(19) United States
(12) Patent Application Publication
(10) Pub. No.: US 2003/0150556 A1
(43) Pub. Date: Aug. 14, 2003

(54) Fibrous product containing plant seed

(76) Inventor: Charles E. Miller, Tacoma, WA (US)

Correspondence Address: WEYERHAEUSER COMPANY, INTELLECTUAL PROPERTY DEPT., CH 1J27, P.O. BOX 9777, FEDERAL WAY, WA, 98063, US

(21) Appl. No.: 10/340,312

(22) Filed: Jan. 10, 2003

Related U.S. Application Data
(60) Provisional application No. 60/347,512, filed on Jan. 11, 2002.
(60) Provisional application No. 60/416,491, filed on Oct. 4, 2002.

(51) Int. Cl. B32B 31/00

(52) U.S. Cl. 156/297; 156/327; 156/276

(57) ABSTRACT

The present invention provides a fibrous product containing plant seeds. In one embodiment, the product is a laminate having plant seeds and adhesive intermediate first and second fibrous sheets. In another embodiment, the product is an integrally formed, unitary fibrous product that includes plants seeds in a fibrous substrate. In a further embodiment, the product is a fibrous sheet coated with a combination of plant seeds and binder. Methods for making the fibrous product are also provided.

### CROSS-REFERENCES TO RELATED APPLICATIONS

The present application claims the benefit of U.S. Provisional Application No. 60/347,512, filed Jan. 11, 2002, and U.S. Provisional Application No. 60/416,491, filed Oct. 4, 2002.

### FIELD OF THE INVENTION

The present invention relates to a fibrous product containing plant seeds.

### BACKGROUND OF THE INVENTION

Seed mats to establish the growth of grass turf have become widely used. The use of seed mats offers several advantages over direct seeding methods. Because of their flexible and blanket nature, seed mats can cover a variety of terrains and topographies. Ideally, a seed mat will have sufficient structural strength to maintain the mat's integrity during initial placement, germination, and subsequent turf development. Seed mats can also prevent or lessen erosion of soil that may be susceptible to erosion due to topography or other environmental reasons.

In contrast to direct seeding, the use of seed mats to establish a seed bed can be simpler, more efficient, and more effective. By virtue of their manufacture, seed mats can provide a seed bed in which the seeds are relatively uniformly distributed, which although advantageous can be difficult to achieve under field conditions. Furthermore, the seed mat can provide an environment that fosters seed germination and the establishment of seedlings more so than soil itself. This can be particularly important with respect to maintaining a desirable moisture content and nutritive environment for the germinating seed.

Although seed mats have had a relatively long developmental period and through that period have become increasingly sophisticated, there remain problems with seed mats, their manufacture, and their use. Accordingly, a need exists for a seed mat having sufficient structural integrity to be readily manufactured, handled, shipped, and applied to a soil surface and provides an environment that facilitates the germination and establishment of a seed bed. The present invention seeks to fulfill these needs and provides further related advantages.

### SUMMARY OF THE INVENTION

In one aspect, the present invention provides a fibrous product containing plant seeds. The product is a carrier mat for seeds and can be used to germinate seeds. In one embodiment, the seeds are grass seeds and the fibrous product ultimately provides a grass mat.

In one embodiment, the product is a laminate having plant seeds and adhesive intermediate first and second fibrous sheets.

In another embodiment, the product is an integrally formed, unitary fibrous product that includes plants seeds in a fibrous substrate.

In a further embodiment, the product is a fibrous sheet coated with a combination of plant seeds and binder.

In another aspect of the invention, methods for making a fibrous product containing plant seeds are provided.

In one method, adhesive and plant seeds are applied to a major surface of a first fibrous sheet followed by the application of a second fibrous sheet to the first sheet's treated surface to provide the product laminate.

In another method, the fibrous product is made by depositing a combination of fibers and plant seed on a forming wire to provide a wet composite that is then dried to provide a unitary sheet containing plant seeds.

In a further embodiment, the binder and plant seeds are applied to a fibrous sheet that is dried to provide the fibrous product.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a cross-sectional view of a representative laminate fibrous product of the invention;

FIG. 1B is a cross-sectional view of a representative laminate fibrous product of the invention having absorbent material in one of the fibrous sheets;

FIG. 2 is a cross-sectional view of another representative fibrous product of the invention;

FIGS. 3A-3C are cross-sectional views of representative unitary fibrous products of the invention;

FIG. 4 is a cross-sectional view of another representative fibrous product of the invention;

FIG. 5 is a schematic illustration of a representative method for making a fibrous product of the invention;

FIG. 6 is a schematic diagram of a representative twin-wire forming device and method for making a fibrous product of the present invention;

FIG. 7 is a photograph illustrating a representative fibrous sheet useful in the fibrous product of the invention, the sheet has been mechanically treated to include slits;

FIG. 8 is a photograph illustrating a representative fibrous sheet useful in the fibrous product of the invention, the sheet has been mechanically treated to include slits;

FIG. 9 is a graph illustrating the effect of basis weight and amount of crosslinked fiber (XL) on sprout breakthrough for representative fibrous products of the invention;

FIG. 10 is a graph illustrating the effect of the amount of crosslinked fiber and basis weight on sprout breakthrough for representative fibrous products of the invention;

FIG. 11 is a graph illustrating the effect of the amount of absorbent material and basis weight on sprout breakthrough for representative fibrous products of the invention;

FIG. 12 is a graph illustrating the effect of the amount of absorbent material and basis weight on breakthrough for representative fibrous products of the invention;

FIG. 13 is a table summarizing percent sprout breakthrough for representative fibrous products of the invention compared to control after 4 days;

FIG. 14 is a table summarizing percent sprout breakthrough for representative fibrous products of the invention after 4, 9, and 14 days;

FIG. 15 is a table summarizing percent sprout breakthrough for controls after 4, 9, and 14 days;

FIG. 16 is a table summarizing sprout breakthrough relative to control for representative fibrous products of the invention after 4, 9, and 14 days; and

FIG. 17 is a table summarizing the tensile strength of representative fibrous products of the invention;

FIG. 18 is a table summarizing sprout breakthrough relative to control for representative fibrous products of the invention; and

FIG. 19 is a graph illustrating percent sprout breakthrough relative to control for representative fibrous products of the invention.

### DETAILED DESCRIPTION OF THE PREFERRED EMBODIMENT

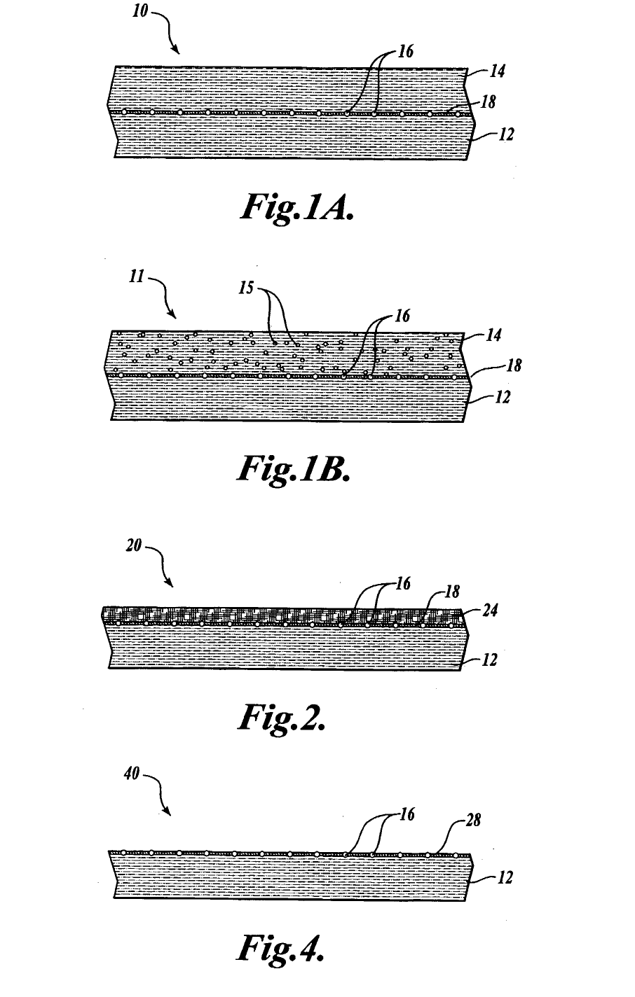

In one aspect, the present invention provides a fibrous product containing plant seeds. The product is a carrier mat for seeds and can be used to germinate seeds. In one embodiment, the seeds are grass seeds and the fibrous product ultimately provides a grass mat. Representative fibrous products of the invention are illustrated in FIGS. 1-4.

In one embodiment, the fibrous product of the invention is a laminate having plant seeds and adhesive intermediate first and second fibrous sheets. Representative laminate fibrous products of the invention are illustrated in FIGS. 1 and 2.

The amount and type of seed contained within the fibrous product can vary depending on the desired product. In one embodiment, the product includes about 100 seeds per 36 square inches of the product. In addition to grass seeds, the product can include other types of seeds.

Referring to FIG. 1A, representative fibrous product 10 includes first fibrous sheet 12, second fibrous sheet 14, plant seeds 16, and adhesive 18. Referring to FIG. 1B, representative fibrous product 11 includes first fibrous sheet 12, second fibrous sheet 14 having absorbent material 15 distributed in the fibrous sheet, plant seeds 16, and adhesive 18. Referring to FIG. 2, representative fibrous product 20 includes first fibrous sheet 12, second fibrous sheet 24, plant seeds 16, and adhesive 18. As described below, fibrous sheets 12 and 14 may be the same or different. Fibrous sheet 24 is a paper sheet, for example, a tissue or toilet paper sheet. For embodiments having a paper sheet, one or more sheets can be used.

In one embodiment, fibrous sheets 12 and 14 can include crosslinked cellulosic fibers. Such fibrous sheets include from about 20 to about 100 percent by weight crosslinked fibers based on the total weight of the fibrous sheet. Fibrous sheets 12 and 14 can also include other fibers, for example, recycled fibers or other biodegradable fibers. Suitable recycled fibers include old corrugated cardboard (OCC), virgin fiber, brownstock fiber, or other recycled fiber. Other suitable fibers include wood pulp fibers such as bleached and unbleached kraft pulp fibers. These fibrous sheets can have a basis weight in the range from about 30 to about 150 gsm. In one embodiment, sheets 12 and 14 have a basis weight of about 90 gsm. Fibrous products 10 and 11 can include sheets 12 and 14 that are the same or different.

As noted above, in one embodiment, the fibrous sheet useful in the present invention includes crosslinked cellulosic fibers. The crosslinked fibers provide the fibrous sheet with porosity or pathways for the shoots and sprouts to grow through the sheet. Any one of a number of crosslinking agents and crosslinking catalysts, if necessary, can be used to provide the crosslinked fibers to be included in the layer. The following is a representative list of useful crosslinking agents and catalysts. Each of the patents noted below is expressly incorporated herein by reference in its entirety.

Suitable urea-based crosslinking agents include substituted ureas such as methylolated ureas, methylolated cyclic ureas, methylolated lower alkyl cyclic ureas, methylolated dihydroxy cyclic ureas, dihydroxy cyclic ureas, and lower alkyl substituted cyclic ureas. Specific urea-based crosslinking agents include dimethyldihydroxy urea (DMDHU, 1,3-dimethyl-4,5-dihydroxy-2-imidazolidinone), dimethyloldihydroxyethylene urea (DMDHEU, 1,3-dihydroxymethyl-4,5-dihydroxy-2-imidazolidinone), dimethylol urea (DMU, bis[N-hydroxymethyl]urea), dihydroxyethylene urea (DHEU, 4,5-dihydroxy-2-imidazolidinone), dimethylolethylene urea (DMEU, 1,3-dihydroxymethyl-2-imidazolidinone), and dimethyldihydroxyethylene urea (DMeDHEU or DDI, 4,5-dihydroxy-1,3-dimethyl-2-imidazolidinone).

Suitable crosslinking agents include dialdehydes such as C₂-C₈ dialdehydes (e.g., glyoxal), C₂-C8 dialdehyde acid analogs having at least one aldehyde group, and oligomers of these aldehyde and dialdehyde acid analogs, as described in U.S. Pat. Nos. 4,822,453; 4,888,093; 4,889,595; 4,889,596; 4,889,597; and 4,898,642. Other suitable dialdehyde crosslinking agents include those described in U.S. Pat. Nos. 4,853,086; 4,900,324; and 5,843,061.

Other suitable crosslinking agents include aldehyde and urea-based formaldehyde addition products. See, for example, U.S. Pat. Nos. 3,224,926; 3,241,533; 3,932,209; 4,035,147; 3,756,913; 4,689,118; 4,822,453; 3,440,135; 4,935,022; 3,819,470; and 3,658,613.

Suitable crosslinking agents include glyoxal adducts of ureas, for example, U.S. Pat. No. 4,968,774, and glyoxal/cyclic urea adducts as described in U.S. Pat. Nos. 4,285,690; 4,332,586; 4,396,391; 4,455,416; and 4,505,712.

Other suitable crosslinking agents include carboxylic acid crosslinking agents such as polycarboxylic acids. Polycarboxylic acid crosslinking agents (e.g., citric acid, propane tricarboxylic acid, and butane tetracarboxylic acid) and catalysts are described in U.S. Pat. Nos. 3,526,048; 4,820,307; 4,936,865; 4,975,209; and 5,221,285. The use of C₂-C₉ polycarboxylic acids that contain at least three carboxyl groups (e.g., citric acid and oxydisuccinic acid) as crosslinking agents is described in U.S. Pat. Nos. 5,137,537; 5,183,707; 5,190,563; 5,562,740, and 5,873,979.

Polymeric polycarboxylic acids are also suitable crosslinking agents. Suitable polymeric polycarboxylic acid crosslinking agents are described in U.S. Pat. Nos. 4,391,878; 4,420,368; 4,431,481; 5,049,235; 5,160,789; 5,442,899; 5,698,074; 5,496,476; 5,496,477; 5,728,771; 5,705,475; and 5,981,739. Polyacrylic acid and related copolymers as crosslinking agents are described U.S. Pat. Nos. 5,549,791 and 5,998,511. Polymaleic acid crosslinking agents are described in U.S. Pat. No. 5,998,511.

Specific suitable polycarboxylic acid crosslinking agents include citric acid, tartaric acid, malic acid, succinic acid, glutaric acid, citraconic acid, itaconic acid, tartrate monosuccinic acid, maleic acid, polyacrylic acid, polymethacrylic acid, polymaleic acid, polymethylvinylether-co-maleate copolymer, polymethylvinylether-co-itaconate copolymer, copolymers of acrylic acid, and copolymers of maleic acid.

Other suitable crosslinking agents are described in U.S. Pat. Nos. 5,225,047; 5,366,591; 5,556,976; and 5,536,369.

Suitable catalysts can include acidic salts, such as ammonium chloride, ammonium sulfate, aluminum chloride, magnesium chloride, magnesium nitrate, and alkali metal salts of phosphorous-containing acids. In one embodiment, the crosslinking catalyst is sodium hypophosphite.

Mixtures or blends of crosslinking agents and catalysts can also be used.

The crosslinking agent is applied to the cellulosic fibers in an amount sufficient to effect intrafiber crosslinking. The amount applied to the cellulosic fibers can be from about 1 to about 10 percent by weight based on the total weight of fibers. In one embodiment, crosslinking agent in an amount from about 4 to about 6 percent by weight based on the total weight of fibers.

In addition to crosslinked fibers, in certain embodiments, the fibrous sheet can also include noncrosslinked cellulosic fibers. Suitable cellulosic fibers include those known to those skilled in the art and include any fiber or fibrous mixture from which a fibrous web or sheet can be formed.

Although available from other sources, cellulosic fibers are derived primarily from wood pulp. Suitable wood pulp fibers for use with the invention can be obtained from well-known chemical processes such as the kraft and sulfite processes, with or without subsequent bleaching. Pulp fibers can also be processed by thermomechanical, chemithermomechanical methods, or combinations thereof. The preferred pulp fiber is produced by chemical methods. Groundwood fibers, recycled or secondary wood pulp fibers, bleached and unbleached wood pulp fibers, and CTMP fibers can be used. Softwoods and hardwoods can be used. Details of the selection of wood pulp fibers are well known to those skilled in the art. These fibers are commercially available from a number of companies, including Weyerhaeuser Company, the assignee of the present invention. For example, suitable cellulose fibers produced from southern pine that are useful in the present invention are available from Weyerhaeuser Company under the designations CF416, NF405, PL416, FR516, and NB416. Suitable cellulose fibers include unbleached Douglas fir pulp fibers available from Weyerhaeuser Company under the designation Sockeye.

The wood pulp fibers useful in the present invention can also be pretreated prior to use. This pretreatment may include physical treatment, such as subjecting the fibers to steam, or chemical treatment. Other pretreatments include incorporation of antimicrobials, pigments, dyes and densification or softening agents. Fibers pretreated with other chemicals, such as thermoplastic and thermosetting resins also may be used. Combinations of pretreatments also may be employed. Treatments can also be applied after formation of the fibrous product in post-treatment processes, examples of which include the application of surfactants or other liquids, which modify the surface chemistry of the fibers, and the incorporation of antimicrobials, pigments, dyes, and densification or softening agents.

In other embodiments, the fibrous sheets that make up the laminate do not include crosslinked cellulosic fibers. In these embodiments, the first and second fibrous sheets can be the same or different. In some embodiments, at least one of the fibrous sheets includes absorbent material (e.g., superabsorbent polymer). Suitable absorbent materials are described below. In this embodiment, the absorbent material in the product absorbs water, swells, and opens the product structure thereby reducing its density and providing a fibrous sheet with porosity and pathways for the shoots and sprouts to grow upward through the sheet. The absorbent material can also serve as a water reservoir to provide the germinating seed and emerging seedling with water. The absorbent material can be incorporated into the fibrous sheet during the sheet's formation. Absorbent material may be present in either one or both fibrous sheets. In one embodiment, the top sheet (i.e., the sheet through which the sprout emerges) includes absorbent material (see, for example, FIG. 1B). The absorbent material can be present in the product in an amount from about 5 to about 20 percent by weight based on the weight of the product. In other embodiments, the product has a slitted surface (e.g., the top sheet is slitted). The slitted surface allows sprouts to readily emerge from the product.

As noted above, the laminate's fibrous sheets are sufficiently open to allow a seedling to breakthrough or emerge from the sheet. In one embodiment, the fibrous sheet includes fibers that impart the sheet with openness sufficient to allow a seedling to readily emerge from the sheet. Wood pulp fibers that impart openness to the sheets include relatively stiff fibers having low density that do not conform their shape and that have relatively few interfiber bonding sites compared to conventional bleached wood pulp fibers. These fibers can be characterized as having relatively high lignin content and have kappa values greater than about 10, preferably greater than about 15, and more preferably greater than about 25. Suitable fibers have a kappa value from about 10 to about 125. Suitable fibers include unbleached interior Douglas fir pulp fibers commercially available from Weyerhaeuser Company under the designation Sockeye. The term “interior” refers to Douglas fir found in the interior of British Columbia, Calif. In one embodiment, the fibrous sheet includes about 100 percent by weight unbleached interior Douglas fir pulp fibers.

The fibrous sheets also provide structural integrity to the laminate. In one embodiment, the fibrous sheets include reinforcing fibers. Reinforcing fibers are characterized as having relatively strong interfiber association thereby imparting strength to the sheet and laminate. Such fibers can include wood pulp fibers such as southern pine fibers commercially available from Weyerhaeuser Company under the designation NB416.

To optimize the openness and strength of the fibrous sheets, blends of fibers can also be used. In general, the fibrous sheet can include up to about 10 percent by weight reinforcing fibers (e.g., southern pine fibers). In one embodiment, the fibrous sheet includes about 95 percent by weight unbleached interior Douglas fir pulp fibers and about 5 percent by weight southern pine fibers. In another embodiment, the fibrous sheet includes about 90 percent by weight unbleached interior Douglas fir pulp fibers and about 10 percent by weight southern pine fibers.

In one embodiment, the product includes first and second fibrous sheets, each having a basis weight of about 40 g/m², and each composed of 100 percent unbleached interior Douglas fir pulp fibers (designated Sockeye in the Figures).

In another embodiment, the product includes first and second fibrous sheets, each having a basis weight of about 70 g/m², and each composed of 100 percent unbleached interior Douglas fir pulp fibers.

In another embodiment, the product includes first and second fibrous sheets, each having a basis weight of about 70 g/m². Each sheet includes about 95 percent by weight unbleached interior Douglas fir pulp fibers and about 5 percent by weight southern pine fibers (designated NB416 in the Figures). In this embodiment, one sheet includes absorbent material (e.g., a superabsorbent polymer that is a crosslinked polyacrylate) (designated SAP in the Figures) present in about 10 percent by weight based on the weight of the sheet.

In another embodiment, the product includes first and second fibrous sheets, each having a basis weight of about 100 g/m². Each sheet includes about 95 percent by weight unbleached interior Douglas fir pulp fibers and about 5 percent by weight southern pine fibers. In this embodiment, one sheet includes absorbent material present in about 10 percent by weight based on the weight of the sheet.

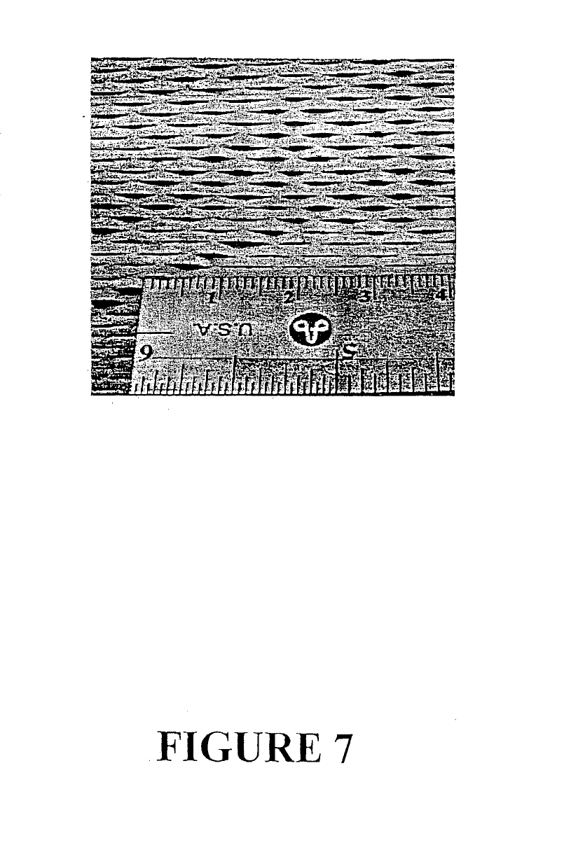

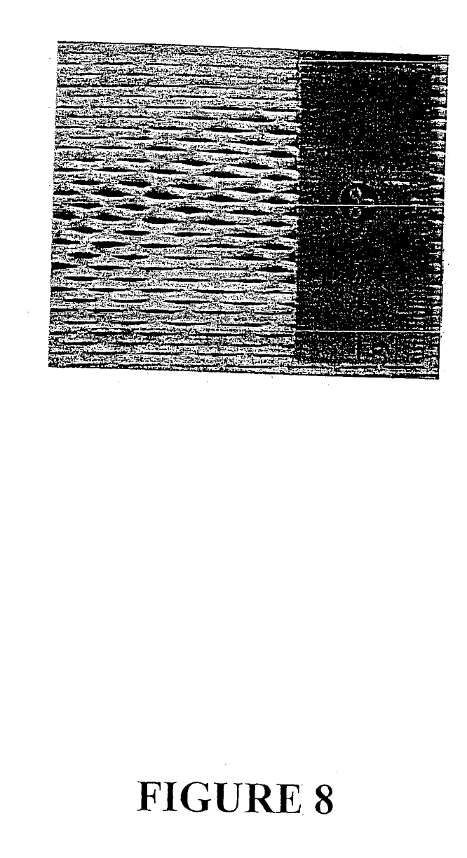

In another embodiment, the product includes first and second fibrous sheets, each having a basis weight of about 130 g/m², and each composed of 100 percent unbleached interior Douglas fir pulp fibers. In this embodiment, the surface of the laminate includes slits. The laminate includes a fibrous sheet that has been mechanically treated post-formation to include slits. The slits are aligned in rows and run in the machine direction of sheet. The slits are offset from row to row. The slits allow access for the seed sprouts to penetrate the fibrous sheet and to emerge from the laminate. A representative fibrous sheet that has been mechanically treated to include slits is shown in FIGS. 7 and 8.

In a further embodiment, the product includes first and second fibrous sheets, each having a basis weight of about 130 g/m². Each sheet includes about 95 percent by weight unbleached interior Douglas fir pulp fibers and about 5 percent by weight southern pine fibers. In this embodiment, one sheet includes absorbent material present in about 10 percent by weight based on the weight of the sheet. In this embodiment, the surface of the laminate is slitted as described above.

The preparation of representative laminate fibrous products and their component fibrous sheets are described in Example 4. The germination of seeds from these products is also described in Example 4.

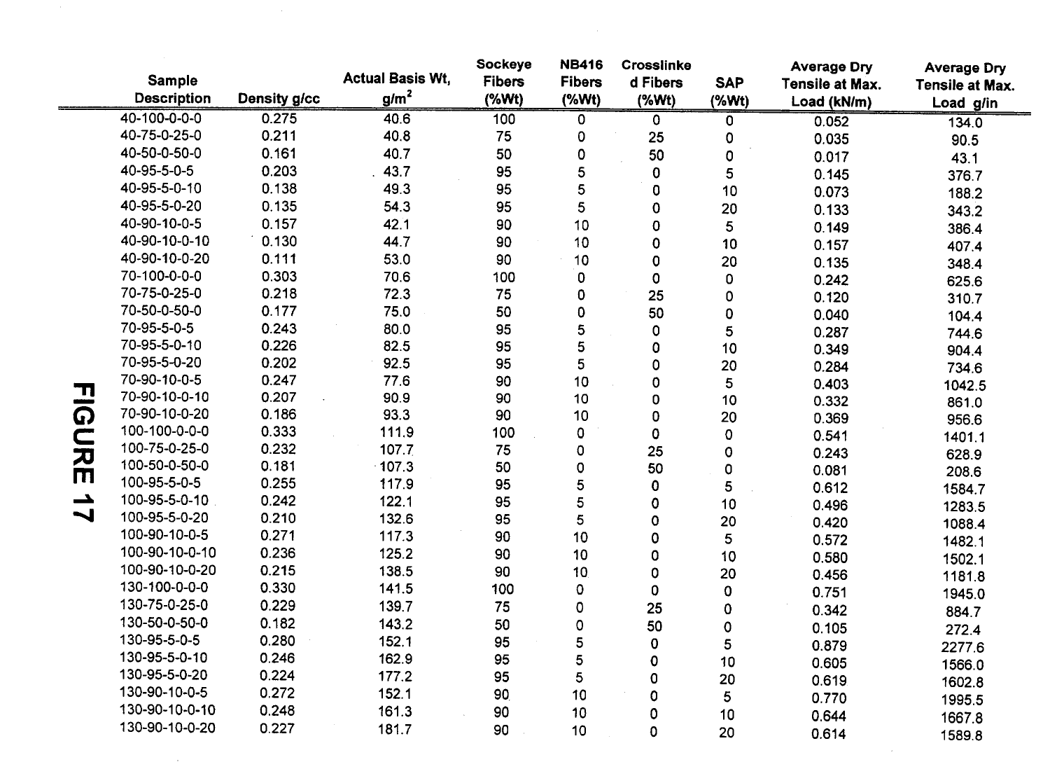

The tensile strength of fibrous sheets useful in making representative fibrous products of the invention is tabulated in FIG. 17. The tensile strength of the fibrous sheet ranges from about 0.05 to about 1.0 kN/m as measured by TAPPI method T494 om96. FIG. 17 summarizes the tensile strength of fibrous sheets useful in making representative fibrous products having a variety of compositions (i.e., varying amounts and types of fibers and absorbent material). In the figure, the sample is described using a key. For example, 40-100-0-0-0 refers to a fibrous sheet having a basis weight of about 40 gsm and includes 100 percent unbleached fiber (designated Sockeye), 0 percent southern pine fiber (designated NB416), 0 percent crosslinked fiber, and 0 percent absorbent material (SAP). Generally, tensile strength increases with increasing basis weight, and tensile strength decreases with increasing crosslinked fiber content.

The fibrous sheets can be formed by a variety of methods including those known in the art. The sheets can be made on tissue, towel, or medium weight paper machines. Fibrous sheets can be formed using conventional papermaking machines including, for example, Rotoformer, Fourdrinier, inclined wire Delta former, and twin-wire machines, among others. The fibrous sheets can be formed by devices and processes that include a twin-wire configuration (i.e., twin-forming wires). Representative methods for making fibrous sheets described in PCT/US99/05997 (Method for Forming a Fluted Composite), PCT/US99/27625 (Reticulated Absorbent Composite), and U.S. patent application No. 10/002,844, filed Nov. 14, 2001 (Crosslinked Cellulosic Product Formed by Extrusion Process), each incorporated herein by reference in its entirety, can be adapted to make the fibrous sheets useful in the present invention.

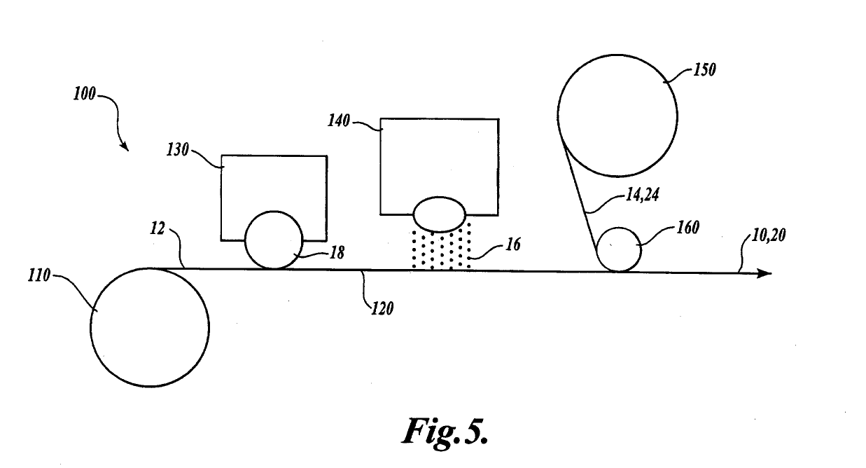

A schematic illustration of a representative device and method for making a laminate product of the invention is illustrated in FIG. 5. In the method, adhesive and plant seeds are applied to a major surface of a first fibrous sheet followed by the contacting the first sheet's treated surface with a second fibrous sheet to provide the product laminate.

Referring to FIG. 5, device 100 includes a first sheet supply 110, moving support 120, binder (or adhesive) supply and applicator 130, seed supply and applicator 140, second sheet supply 150, and pressure applicator 160. In the method, first sheet 12 is transported from supply 110 on support 120 to a position where binder 18 is applied by binder supply and applicator 130. The binder treated sheet is then transported to a position where plant seed 16 is applied by seed supply and applicator 140. The resulting sheet is then contacted with second fibrous sheet 14 (or 24) and compacted by roller 160 to provide laminate fibrous product 10 (or 20 depending on the nature of the second fibrous sheet).

Adhesive can be applied to the fibrous sheet by a roll coater, sprayer, or other suitable applicator. In one embodiment, adhesive is sprayed onto the fibrous sheet to provide individual, noncoalesced droplets on the fibers. The adhesive is suitably applied in an amount sufficient to achieve a satisfactory bond with the seeds to retain the seeds in the product and to achieve a satisfactory bond with the second fibrous sheet to provide a laminate having sufficient strength. In one embodiment, adhesive is applied by spray in an amount from about 5 to about 10 g per about 1000 square inches of fibrous sheet. It will be appreciated that the adhesive that is applied to the fibrous sheet is applied in an amount that does result in the formation of an adhesive film that would adversely affect the seedlings' emergence from the laminate.

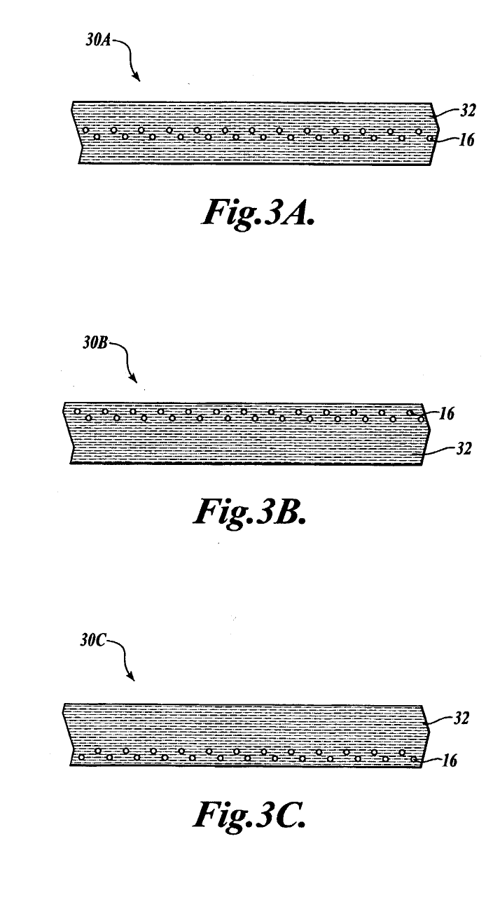

In another embodiment, the fibrous product of the invention is an integrally formed, unitary fibrous product that includes plants seeds in a fibrous substrate. Representative unitary fibrous products are illustrated in FIGS. 3A-3C.

Referring to FIGS. 3A-3C, unitary fibrous products 30A, 30B, and 30C each comprises a fibrous substrate 32 that includes plant seeds 16. Products 30A, 30B, and 30C differ in the position of plant seeds within the product. While the plant seeds are centrally located in product 30A, the plant seeds are located more toward the outer surfaces of the product in products 30B and 30C. Where the fibrous substrate is homogeneous, products 30B and 30C are identical.

Unitary fibrous products of the invention include crosslinked fibers, and optionally others fibers, as described above.

Representative unitary fibrous products can be formed by devices and processes that include a twin-wire configuration (i.e., twin-forming wires). Representative methods for making fibrous composites described in PCT/US99/05997 (Method for Forming a Fluted Composite), PCT/US99/27625 (Reticulated Absorbent Composite), and U.S. patent application No. 10/002,844, filed Nov. 14, 2001 (Crosslinked Cellulosic Product Formed by Extrusion Process), each incorporated herein by reference in its entirety, can be adapted to make the unitary fibrous product of the invention. In one embodiment, the unitary composite is made by foam-forming process.

In one embodiment, the product is formed by a wetlaid process using the components described above. The wetlaid method can be practiced on an inclined wire Delta former. In another embodiment, the product is formed by a foam-forming method using the components described above. Wetlaid and foam-forming processes can be practiced on a twin-wire former.

A representative method for forming a representative unitary product of the invention includes the following steps:

(a) forming a first fibrous slurry comprising fibers in an aqueous dispersion medium; for a foam method, the slurry is a foam that includes, in addition to fibers, a surfactant;

(b) forming a second fibrous slurry comprising fibers in an aqueous dispersion medium; for a foam method, the slurry is a foam that includes, in addition to fibers, a surfactant;

(c) moving a first foraminous element (e.g., a forming wire) in a first path;

(d) moving a second foraminous element in a second path;

(e) passing the first slurry into contact with the first foraminous element moving in a first path;

(f) passing the second slurry into contact with the second foraminous element moving in the second path; and

(g) passing a third material (e.g., plant seeds) between the first and second slurries such that the third material does not contact either the first of second foraminous elements; and

(h) forming a fibrous web from the first and second slurries by withdrawing liquid from the slurries through the first and second foraminous elements.

The foam-forming method is suitably carried out on a twin-wire former, preferably a vertical former, and more preferably, a vertical downflow twin-wire former. In the vertical former, the paths for the foraminous elements are substantially vertical.

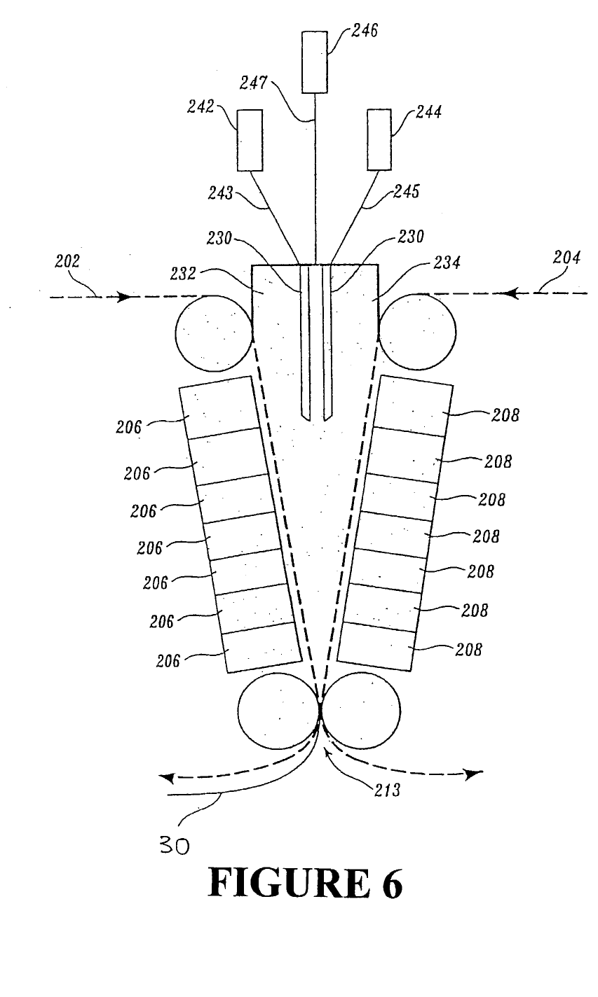

A representative vertical downflow twin-wire former useful in practicing a method of the invention is illustrated in FIG. 6. Referring to FIG. 6, the former includes a vertical headbox assembly having a former with a closed first end (top), closed first and second sides and an interior volume. A second end (bottom) of the former is defined by moving first and second foraminous elements, 202 and 204, and forming nip 213. The interior volume defined by the former's closed first end, closed first and second sides, and first and second foraminous elements includes an interior structure 230 extending from the former first end and toward the second end. The interior structure defines a first volume 232 on one side thereof and a second volume 234 on the other side thereof. The former further includes supply 242 and means 243 for introducing a first fiber/foam slury into the first volume, supply 244 and means 245 for introducing a second fiber/foam slurry into the second volume, and supply 246 and means 247 for introducing a third material (e.g., plant seeds) into the interior structure. Means for withdrawing liquid/foam (e.g., suction boxes 206 and 208) from the first and second slurries through the foraminous elements to form a web are also included in the headbox assembly.

In the method, the twin-wire former includes a means for introducing at least a third material (e.g., plant seeds) through the interior structure. The first and second fiber/foam slurries can include the same components (e.g., crosslinked cellulosic fibers, noncrosslinked fibers, or recycled fibers) and have the same composition.

Depending upon the nature of the product to be formed, the first and second fiber/foam slurries may be the same as or different from each other, and the same as or different from the third material.

The means for withdrawing liquid/foam from the first and second slurries through the foraminous elements to form a web on the foraminous elements are also included in the headbox assembly. The means for withdrawing liquid/foam can include any conventional means for that purpose, such as suction rollers, pressing rollers, or other conventional structures. In a preferred embodiment, first and second suction box assemblies are provided and mounted on the opposite sides of the interior structure from the foraminous elements (see boxes 206 and 208).

The fibrous product containing plant seeds is finally produced by drying at a temperature and for a time sufficient without adversely affecting the component plant seeds. Suitable dryers include through-air dryers, among others.

Plant seeds can be incorporated into the fibrous sheet in rows. Methods and devices useful for producing such sheets are described in PCT/US99/05997 (Methods for Forming a Fluted Composite), expressly incorporated herein by reference in its entirety.

In a further embodiment, the product is a fibrous sheet coated with a combination of plant seeds and binder. A representative fibrous product is illustrated in FIG. 4. Referring to FIG. 4, fibrous product 40 includes plant seeds 16 adhered to fibrous sheet 12 with binder 28. Fibrous sheet 12 can include crosslinked fibers, noncrosslinked fibers, and other materials (e.g., absorbent material), as described above.

For this embodiment, a heatless-bonding method is preferred. The fibrous sheet can be formed by any one of a variety of methods including, for example, wetlaid, airlaid, foam, or extrusion methods, as noted above. The plant seeds are then adhered to the fibrous sheet with a heatless binder. Suitable heatless binders include, for example, cellulose acetate and acetone, starch-based adhesives, or corn oils, which can be applied warm and then solidify on cooling. Alternatively, the plant seed can be applied to the fibrous sheet by a coater (e.g., a foam coater) in a combination of seed, foaming agent, and binder.

An advantage of such a process for making the fibrous product is that the fibrous sheet can be produced in mass quantities and shipped to regional coating facilities where plant seeds at added “on demand” or with “just in time” delivery thereby providing products with fresh seeds. Such a process minimizes premature germination caused by shipping the fibrous product long distances in hot weather. The process is also amenable to changing seed types, blends, and dosages that may be required depending on the geographical region of end use.

Plant seeds are adhered to the fibrous sheet with a binder or adhesive (see reference numeral 18 in FIGS. 1 and 2, and reference numeral 28 in FIG. 4). The binder or adhesive also serves to adhere the first and second fibrous sheets of the laminate embodiments of the fibrous product. (See FIGS. 1 and 2) Suitable binders or adhesives include starch, sorbitol, glycerin, and glues, among others. In one embodiment, the binder is a vinyl acrylic adhesive. The seed particles may be bound to the fibers by combining the particles with a polymeric binder, which may be water soluble. The polymeric binder is selected from a predetermined group of polymeric binders. The polymeric binders comprise polymeric binder molecules wherein the polymeric binder molecules have at least one hydrogen bonding functionality or coordinate covalent bond forming functionality. Binders may further comprise repeating units, wherein the repeating units have such functionalities on each repeating unit of the polymer, although this is not necessary for adequate binder functions. In accordance with the present invention, the predetermined groups of polymeric binders include the group of binders consisting of polyglycols [e.g., poly(propyleneglycol)], a polycarboxylic acid, a polycarboxylate, a poly(lactone) polyol, such as diols, a polyamide, a polyamine, a polysulfonic acid, a polysulfonate, and combinations thereof. Specific examples of some of these compounds, without limitation, are as follows: polyglycols may include polypropylene glycol (PPG) and polyethylene glycol (PEG); poly(lactone) polyols include poly(caprolactone) diol and poly(caprolactone) triol; polycarboxylic acids include polyacrylic acid (PAA) and polymaleic anhydride; polyamides include polyacrylamide or polypeptides; polyamines include polyethylenimine and polyvinylpyridine; polysulfonic acids or polysulfonates include poly(sodium-4-styrenesulfonate) or poly(2-acrylamido-methyl-1-propanesulfonic acid; and copolymers thereof (for example a polypropylene glycol/polyethylene glycol copolymer). The polymeric binder typically has repeating units. The repeating unit may be the backbone of a compound, such as with a polypeptide, wherein the repeating polyamides occur in the peptide chain. The repeating unit may also refer to units other than backbones, for instance repeating acrylic acid units. In such a case, the repeating units may be the same or different. The binder has a functional group capable of forming a hydrogen bond or a coordinate covalent bond with particles, and a functional group capable of forming a hydrogen bond with the fibers.

Other binders include non-polymeric organic binders selected from a predetermined group of binders that each have a volatility less than water. The vapor pressure of the binder may, for example, be less than 10 mm Hg at 25° C., and more preferably less than 1 mm Hg at 25° C. The non-polymeric binders comprise non-polymeric binder molecules wherein the non-polymeric binder molecules have at least one functional group that forms hydrogen bonds or coordinate covalent bonds with the particles. The predetermined group of non-polymeric binders may include a functional group selected from the group consisting of a carboxyl a carboxylate, a carbonyl, a sulfonic acid, a sulfonate, a phosphate, a phosphoric acid, a hydroxyl, an amide, an amine, and combinations thereof (such as an amino acid or a hydroxy acid) wherein each binder includes at least two such functionalities, and the two functionalities are the same or different. A requirement for the non-polymeric binder is that it have a plurality of functional groups that are capable of hydrogen bonding, or at least one group that can hydrogen bond and at least one group that can form coordinate covalent bonds. As used herein, the term “non-polymeric” refers to a monomer, dimer, trimer, tetramer, and oligomers, although some particular non-polymeric binders are monomeric and dimeric, preferably monomeric.

Certain non-polymeric organic binders are capable of forming five or six membered rings with a functional group on the surface of the particle.

Other alcohols that do not form a five-membered ring also can be used, for example alcohols that do not have hydroxyl groups on adjacent carbons. Examples of suitable alcohols include primary, secondary or tertiary alcohols.

Amino alcohol binders are alcohols that contain an amine group (—NR₂), and include binders such as ethanolamine (2-aminoethanol), and diglycolamine (2-(2-aminoethoxy)ethanol)). Non-polymeric polycarboxylic acids contain more than one carboxylic acid functional group and include such binders as citric acid, propane tricarboxylic acid, maleic acid, butanetetraoarboxylic acid, cyclopentanetetracarboxylic acid, benzene tetracarboxylic acid and tartaric acid. A polyol is an alcohol that contains a plurality of hydroxyl groups, and includes diols such as the glycols (dihydric alcohols) ethylene glycol, propylene glycol and trimethylene glycol; triols such as glycerin (1,2,3-propanetriol); esters of hydroxyl containing binders may also be used, with mono- and di-esters of glycerin, such as monoglycerides and diglycerides, being especially preferred; and polyhydroxy or polycarboxylic acid compounds such as tartaric acid or ascorbic acid (vitamin C).

Hydroxy acid binders are acids that contain a hydroxyl group, and include hydroxyacetic acid (CH₂OHCOOH) and lactic, tartaric, ascorbic, citric, and salicylic acid. Amino acid binders include any amino acid, such as glycine, alanine, valine, serine, threonine, cysteine, glutamic acid, lysine, or β alanine.

Sulfonic acid binders and sulfonates are compounds that contain a sulfonic acid group (—SO₃H) or a sulfonate (—SO₃⁻). Amino-sulfonic acids also can be used. One example of an amino-sulfonic acid binder suitable for the present invention is taurine, which is 2-aminoethanesulfonic acid.

Non-polymeric polyamide binders are small molecules (for example, monomers or dimers) that have more than one amide group, such as oxamide, urea and biuret. Similarly, a non-polymeric polyamine binder is a non-polymeric molecule that has more than one amine group, such as ethylene diamine, EDTA or the amino acids asparagine and glutamine.

In one embodiment, the non-polymeric organic binder is selected from the group consisting of glycerin, a glycerin monoester, a glycerin diester, glyoxal, ascorbic acid, urea, glycine, pentaerythritol, a monosaccharide, a disaccharide, citric acid, taurine, tartaric acid, dipropyleneglycol, an urea derivative, phosphate, phosphoric acid, and combinations thereof (such as hydroxy acids). As used herein, an oligomer refers to a condensation product of polyols, wherein the condensation product contains less than ten monomer units. A polyglycerin oligomer as referred to herein means a condensation product of two or more glycerin molecules. A propylene glycol oligomer as referred to herein means a condensation product of two or more propylene glycol molecules. The non-polymeric binders also include functionalities selected from the group consisting of a carboxyl, a carboxylate, a carbonyl, a sulfonic acid, a sulfonate, a phosphate, a phosphoric acid, a hydroxyl, an amine, an amide, and combinations thereof (such as amino acids and hydroxy acids). The non-polymeric binders may have at least two functionalities from such group, and the groups may be the same or different.

Suitable binders are described in detail in U.S. Pat. No. 5,641,561, expressly incorporated herein by reference.

The fibrous products of the invention described above can include other materials such as, for example, fertilizer, added color, insecticides, pH adjusters, superabsorbent material, and strengthening agents.

As noted above, the fibrous product can include absorbent material. Suitable absorbent material includes superabsorbent materials (e.g., superabsorbent polymers or SAP). Superabsorbent materials generally fall into three classes: starch graft copolymers, crosslinked carboxymethylcellulose derivatives, and modified hydrophilic polyacrylates. Examples of such absorbent polymers include hydrolyzed starch-acrylonitrile graft copolymers, neutralized starch-acrylic acid graft copolymers, saponified acrylic acid ester-vinyl acetate copolymers, hydrolyzed acrylonitrile copolymers or acrylamide copolymers, modified crosslinked polyvinyl alcohol, neutralized self-crosslinking polyacrylic acids, crosslinked polyacrylate salts, carboxylated cellulose, and neutralized crosslinked isobutylene-maleic anhydride copolymers.

Superabsorbent materials are available commercially, for example, polyacrylates from Clariant of Portsmouth, Va. These superabsorbent polymers come in a variety of sizes, morphologies, and absorbent properties (available from Clariant under trade designations such as IM 3500 and IM 3900). Other superabsorbent materials are marketed under the trademarks SANWET (supplied by Sanyo Kasei Kogyo Kabushiki Kaisha), and SXM77 (supplied by Stockhausen of Greensboro, N.C.). Other superabsorbent materials are described in U.S. Pat. No. 4,160,059; U.S. Pat. No. 4,676,784; U.S. Pat. No. 4,673,402; U.S. Pat. No. 5,002,814; U.S. Pat. No. 5,057,166; U.S. Pat. No. 4,102,340; and U.S. Pat. No. 4,818,598, all expressly incorporated herein by reference. Products such as diapers that incorporate superabsorbent materials are described in U.S. Pat. No. 3,699,103 and U.S. Pat. No. 3,670,731.

In certain embodiments, the fibrous product can include a wet strength agent. Suitable wet strength agents include cationic modified starch having nitrogen-containing groups (e.g., amino groups) such as those available from National Starch and Chemical Corp., Bridgewater, N.J.; latex; wet strength resins, such as polyamide-epichlorohydrin resin (e.g., KYMENE 557LX, Hercules, Inc., Wilmington, Del.), and polyacrylamide resin (see, e.g., U.S. Pat. No. 3,556,932 and also the commercially available polyacrylamide marketed by American Cyanamid Co., Stanford, Conn., under the trade name PAREZ 631 N.C.); urea formaldehyde and melamine formaldehyde resins; and polyethylenimine resins. A general discussion on wet strength resins utilized in the paper field, and generally applicable in the present invention, can be found in TAPPI monograph series No. 29, “Wet Strength in Paper and Paperboard”, Technical Association of the Pulp and Paper Industry (New York, 1965).

The following examples are provided to illustrate, not limit, the invention.

### EXAMPLES

### Example 1

### Representative Fibrous Products

In this example, representative laminate fibrous products of the present invention are described. In each of the laminates, the first fibrous sheet (i.e., bottom layer) was prepared from a 50/50 blend of Springfield OCC and unopened crosslinked cellulosic fibers (polyacrylic acid crosslinked fibers) formed by a wetlaid process.

Sample 1. The bottom layer of this laminate was a 191 gsm layer as described above. A vinyl acrylic adhesive (i.e., Elmer's glue) was applied at a rate of about 100 gsm as weighed by spreading the glue out on tin foil and then transferring the glue to the mat. Grass seed (Penntrio) was applied with a Scotts Drop Spreader at a rate of 1.25 lb./1000 sq. ft. The top layer was a 188 gsm fibrous sheet (50/50 blend of Springfield OCC and unopened polyacrylic acid crosslinked fibers) that was 1 mm hole punched every ¼ inch. The top layer was pressed to the bottom layer with a rubber hand roller. The product laminate had a basis weight of 481 gsm, caliper of 2.71 mm, and a density of 0.178 g/cc. In this product, the seeds germinated in four days.

Sample 2. The bottom layer was a 195 gsm sheet as described above. Elmer's glue and grass seed were applied as described above for Sample 1. The top layer was made of three side-by-side rolls of 30 gsm 2-ply toilet tissue. The top layer was pressed to the bottom layer with a rubber hand roller. The product laminate had a basis weight of 336 gsm, caliper of 1.46 mm, and density of 0.23 g/cc. Seeds germinated throughout the product in four days.

Sample 3. The bottom layer was a 202 gsm fibrous sheet as described above. Elmer's glue was applied as described above for Sample 1. Grass seed (KY Bluegrass) was applied by hand at a rate of 1.87 lb./1000 sq. ft. The top layer was made of three side-by-side rolls of 30 gsm 2-ply toilet tissue. The top layer was pressed to the bottom layer with a TAPPI handsheet Couch roller. The product laminate had a basis weight of 340 gsm, caliper of 1.40 mm, and density of 0.24 g/cc. The seeds that did germinate in this mat did so in seven days.

Sample 4. The bottom layer was a 220 gsm fibrous sheet as described above. Elmer's glue was applied as described above for Sample 1. Grass seed (Penncross Bend) was applied by hand at a rate of 1.25 lb./1000 sq. ft. The top layer was made of three side-by-side rolls of 30 gsm 2-ply toilet tissue. The top layer was pressed to the bottom layer with a rubber hand roller. The product laminate had a basis weight of 373 gsm, caliper of 1.5 mm, and density of 0.248 g/cc. The seeds in this product germinated throughout in four days.

Sample 5. The bottom layer was a 243 gsm fibrous sheet as described above. Elmer's glue was applied as described for Sample 1. Grass seed (Tall Fescue) was applied by hand at a rate of 5.75 lb./1000 sq. ft. The top layer was made of three side-by-side rolls of 30 gsm 2-ply toilet tissue. The top layer was pressed to the bottom layer with a rubber hand roller. The product laminate had a basis weight of 390 gsm, caliper of 1.74 mm, and density of 0.224 g/cc. The seeds in this product germinated throughout in four days.

### Example 2

### Representative Fibrous Products

In this example, representative unitary fibrous products of the invention are described. The products described in this example are handsheets (12 inches by 12 inches), having a basis weight of 175 gsm and prepared from a combination of 50/50 Springfield OCC and opened crosslinked cellulosic fibers (polyacrylic acid crosslinked fibers). The handsheets were made by blending the OCC and crosslinked fibers for 2 minutes in water with 1% by weight wet strength agent (KYMENE). Once the fibers were blended, grass seed was added and blending was continued for 15 seconds. The resulting mixture was couched and then pressed once at 30 psi. The wet handsheet was then dried using an M&J Thermalbonder at a setting of 150° F. to a dryness of 10-15% moisture.

Sample 1. Grass seed (Penntrio) was added at 1.25 lb./1000 sq. ft. The product had a basis weight of 191 gsm, caliper of 1.43 mm, and density of 0.134 g/cc. The seeds in this fibrous product germinated in four days.

Sample 2. Grass seed (KY Bluegrass) was added at 1.87 lb./1000 sq. ft. The product had a basis weight of 200 gsm, caliper of 1.63 mm, and density of 0.123 g/cc.

Sample 3. Grass seed (Tall Fescue) was added at 5.75 lb./1000 sq. ft. The product had a basis weight of 223 gsm, caliper of 1.63 mm, and density of 0.137 g/cc. The seeds in this fibrous product germinated in four days.

### Example 3

### Performance Characteristics of Representative Fibrous Products

In this example, representative unitary fibrous products and their performance characteristics are described. The fibrous products were handsheets (12 inches by 12 inches) made from a 50/50 blend of unbleached pine fibers and crosslinked cellulosic fibers (polyacrylic acid crosslinked fibers) formed by a wetlaid process. The handsheets were made by blending the pine fibers for 2 minutes in water and then adding unopened polyacrylic acid crosslinked fibers to the slurry and blending for 2 minutes. Grass seed was then added to the slurry and blended for 15 seconds. The slurry was then couched and pressed once at 30 psi. The resulting wet sheet was dried in a M&J Thermalbonder at a setting of 160° F. to a 10-15% moisture content. The unbleached pine fibers had a Canadian Standard Freeness of 740 and a consistency of 32.97%. The polyacrylic acid crosslinked fibers had a 4% moisture content.

The characteristics and performance properties of the fibrous products are presented in Table 1 below. Each of the products had a basis weight of 175 gsm. Samples A-G differ by the type and amount of grass seed. Sample A included Turf Builder Grass Seed, Blended Rye, 2.27 g; Sample B included Scotts Tall Fescue, 2.09 g; Sample C included Blender KY31 Tall Fescue, 2.95 g; Sample D included KY Bluegrass, 0.68 g; Sample E included Penntrio, 0.45 g; Sample F included Penncross Bend, 0.45 g; and Sample G included Sunstar Bermuda, 0.68 g.

TABLE 1
The characteristics and
germination properties of representative fibrous products.

| | | | | Days to | Seeds/ | Grass/ | % Germination |
|---|---|---|---|---|---|---|---|
| Sample | % Moisture | Caliper | Density | Sprout | sqin | sqin | at 10 days |
| A | 11.44 | 2.55 | 0.078 | 1 | 6.4 | 4.96 | 78% |
| B | 12.24 | 2.55 | 0.077 | 3 | 7.6 | 4.78 | 63% |
| C | 15.39 | 2.7 | 0.077 | 2 | 8.9 | 4.78 | 54% |
| D | 12.57 | 2.4 | 0.076 | 4 | 15.5 | 5.83 | 38% |
| E | 12.61 | 2.55 | 0.070 | 2 | 43.3 | 16 | 37% |
| F | 12.56 | 2.75 | 0.065 | 2 | 38.6 | 15.3 | 40% |
| G | 10.49 | 2.45 | 0.074 | 4 | 17.5 | 5.2 | 30% |

Control samples were also run for the grasses included in the handsheets in Table 1. Samples H-N include the same grass seeds as Samples A-G, respectively. The germination results are summarized in Table 2.

TABLE 2
Control germination properties.

| | | | | % Germination |
|---|---|---|---|---|
| Sample | Days to Sprout | Seeds/sqin. | Grass/sqin | at 10 days |
| H | 2 | 6.4 | 5.5 | 86% |
| I | 3 | 7.6 | 6.13 | 81% |
| J | 2 | 8.9 | 8.25 | 93% |
| K | 4 | 15.5 | 8.56 | 55% |
| L | 2 | 43.3 | 16.56 | 38% |
| M | 2 | 38.6 | 18.31 | 47% |
| N | 3 | 17.5 | 6.56 | 37% |

The Frazier porosity of the fibrous products in Table 1 are presented in Table 3. The porosity was measured 28 days after planting and is reported in units of cubic feet per minute (cu. ft./min.).

TABLE 3
Porosity of representative fibrous products.

| | Frazier Porosity |
|---|---|
| Sample | cu. ft./min. |
| A | 29.9 |
| B | 30.9 |
| C | 29.9 |
| D | 29.9 |
| E | 30.9 |
| F | 30.9 |
| G | 35.5 |

### Example 4

### Representative Fibrous Laminate Products and Their Germination Properties

In this example, representative laminate fibrous products of the present invention and their germination properties are described. The laminate products described in this example are prepared from fibrous sheets having relatively low basis weights.

Hand Sheet Preparation. Based on the desired composition, wetlaid hand sheets are prepared using procedures established by TAPPI. The cellulose fiber used could be any grade including crosslinked fiber produced by Weyerhaeuser Company. Unbleached fibers and/or crosslinked fibers are preferred. Four 6″×6″ samples are cut from each 12″×12″ hand sheet. In this case, two of the smaller squares are tops and two are bottoms for the two layer laminate design. Two products can be made from each 12″×12″ hand sheet. If superabsorbent polymer (e.g., polyacrylic acid) is desired, this is also added during the hand sheet making process as an add on by mass of the top layer only. One such superabsorbent is SR1001 available from Stockhausen Inc. There are other agricultural superabsorbents available as well.

Laminate Preparation. For each 6″×6″ laminate, there is a top and a bottom layer. A small amount (approximately 5-10 g/1000 in² is preferred) of adhesive (for example, Covinax 169 vinyl acetate adhesive produced and distributed by Franklin International, Columbus, Ohio) is sprayed onto the bottom layer with an airless sprayer. Within a marked 4″×4″ square in the center of the bottom layer, 100 seeds are uniformly dispersed by hand. The seeds used are Winners Rye produced by AgriShop, Tacoma, Wash. (Lot # M120-2-GW25). The composition of the seed blend is noted on the bag as:

| | |
|---|---|
| 59.58% | Dandy Perennial Ryegrass from Oregon |
| 24.7% | Elf Perennial Ryegrass from Oregon |
| 14.79% | Highlife Perennial Ryegrass from Oregon |
| 0.01% | Other |
| 0.91% | Inert matter |
| 0.01% | Weeds |

The top layer is then added to the sample to complete the laminate. The product is then pressed to ensure good adhesion of the top and bottom layer. For simplicity in these samples, the fiber content is the same in both the top and bottom layer. However, the two layers do not have to have the same fiber content.

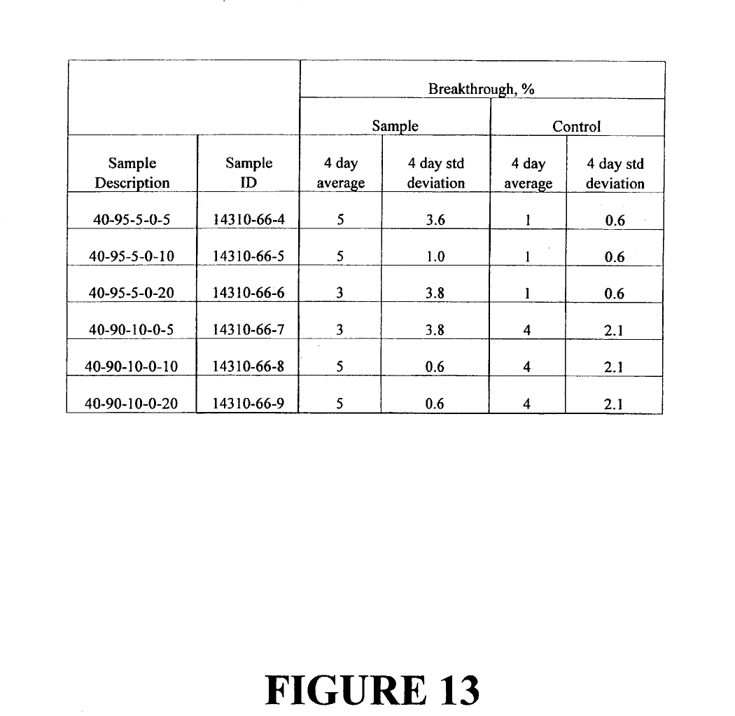

Breakthrough Testing Procedure. For each laminated sample, a 6″6″ test sample was created using the sample preparation described above. Three replicates for each sample were produced and planted in separate growing trays. Each tray contains a 1.75-2 inch layer of BLACK GOLD All Purpose Potting Soil produced by Sun Grow Horticulture Inc., Bellevue, Wash. Along with the samples in each tray, 100 control seeds were also planted. Before planting the samples and control, the soil was watered and allowed to drain. Then the samples and control are planted in the soil. The samples are simply laid on top of the soil and the control seeds are planted in the soil according to the directions on the bag of seed. The trays are then placed in a growth chamber. The growth chamber has controlled daylight from 6 am to 8 pm where the temperature was controlled to about 73-75° F. The lights in the chamber were off from 8 pm to 6 am and the temperature was cooled to a set point of 55° F. The humidity is allowed to change, but was generally 50-60%. On days 4, 9, and 14, the samples and controls were inspected for sprouts. A sprout whose tip had escaped the soil or seed mat was counted as having “broken through”. Any sprouts that did not fully penetrate the seed mat were not counted until the tip was visible. The breakthrough data is summarized in FIGS. 13-16, 18, and 19.

Sample Description Key. The representative fibrous products summarized in FIGS. 13-16, 18 and 19 are described by their composition using the following key.

Example: 40-90-10-0-20

40: Fiber basis weight of top and bottom layers (g/m²)

90: Content of unbleached fiber (%)

10: Content of bleached southern pine fiber (%)

0: Content of crosslinked fiber (%)

20: Amount of SAP added to top layer only (% add on based on top layer basis weight).

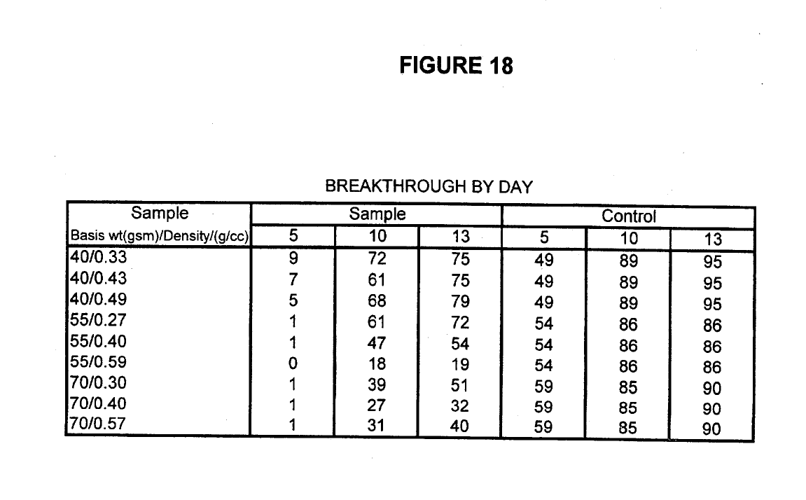

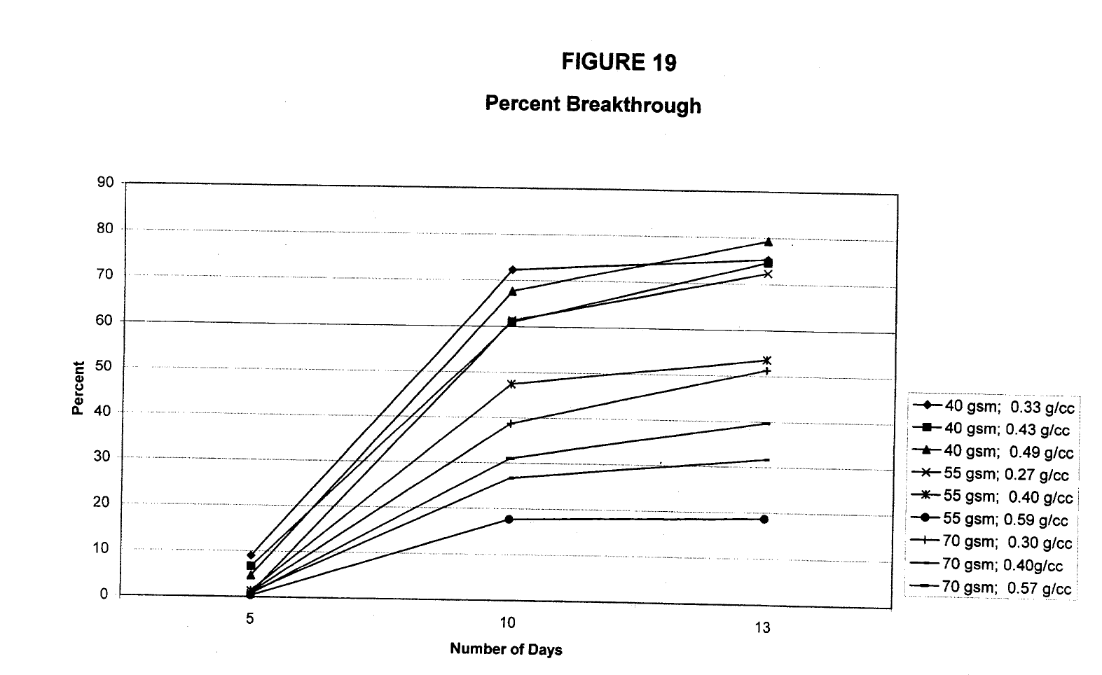

Breakthrough data for representative fibrous products made with fibrous sheets having three basic weights (40, 55, and 70 gsm), each at three densities (0.30, 0.40, and 0.50 g/cc), relative to control, is tabulated in FIG. 18 and illustrated in FIG. 19. These fibrous products were prepared from fibrous sheets including 100 percent unbleached interior Douglas fir pulp fibers: 40-100-0-0-0; 55-100-0-0-0; and 70-100-0-0-0.

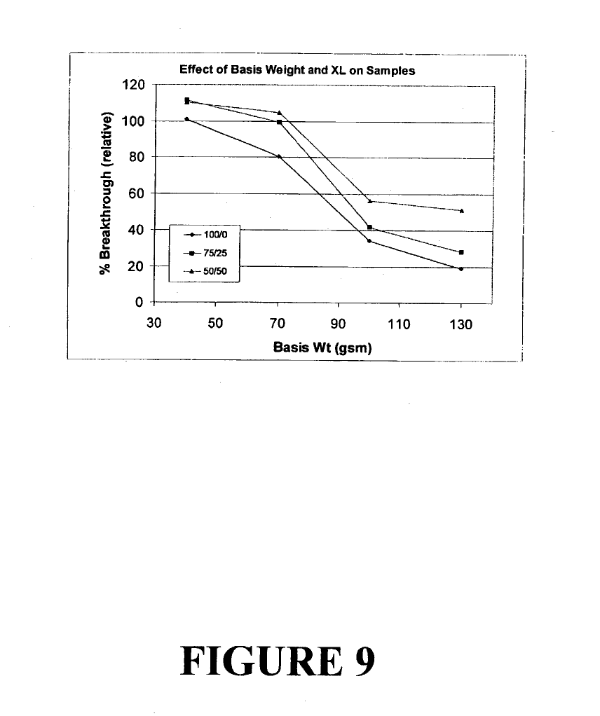

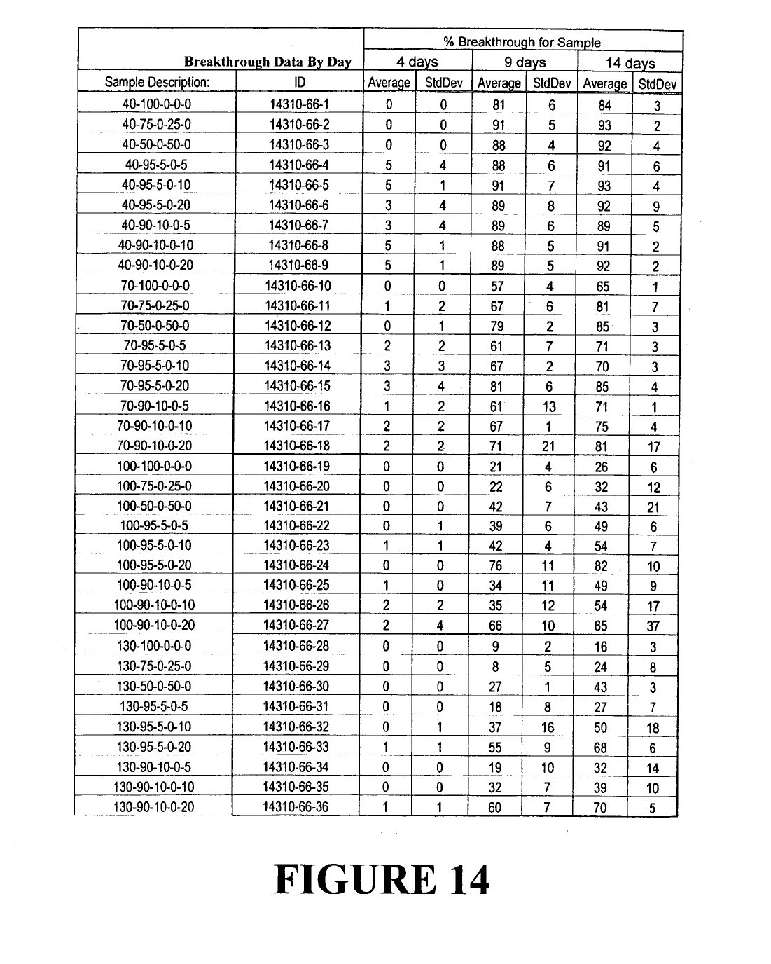

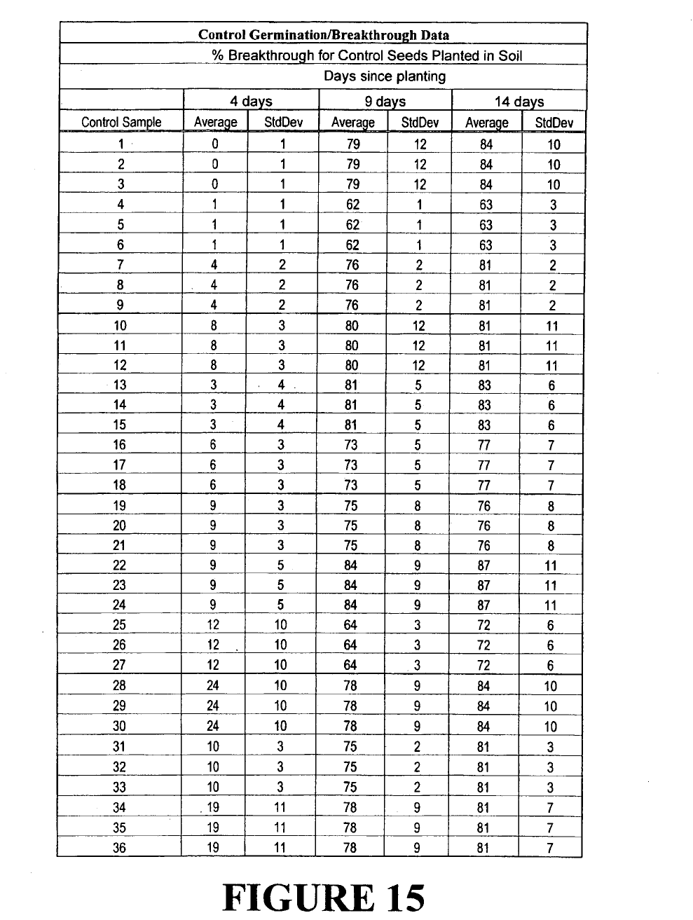

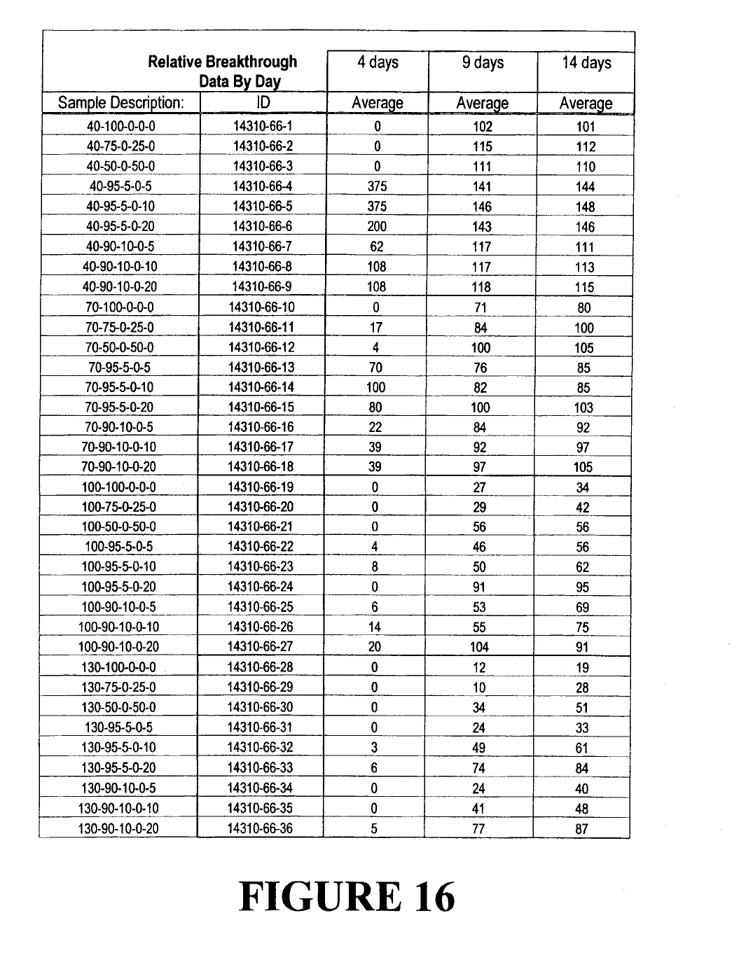

Breakthrough and Control Data. The breakthrough data is shown in FIGS. 14-16. As used herein, the term “breakthrough” refers to the percentage of seeds whose sprout fully penetrates the seed mat. FIG. 14 shows the absolute breakthrough data for each sample. FIG. 15 shows the absolute data for the 36 controls. For the controls, breakthrough is equal to germination as the sprouts need only penetrate the soil. There was one control planted in the soil of each tray next to the sample. FIG. 16 provides the relative breakthrough data for each sample. The relative breakthrough is calculated by taking the sample absolute breakthrough and dividing by the control absolute breakthrough and multiplying by 100. These data were used to generate FIGS. 9-12. When the sample out performs the control, the relative breakthrough is greater than 100.

4 Day Breakthrough Data. In some samples, it was noted that % breakthrough was achieved at a faster rate than the control. This is a highly desirable characteristic in the product and is noted as relative breakthrough values greater than 100. FIG. 13 provides several examples of where the seed mat samples germinated faster than the soil planted control seeds.

14 Day Breakthrough Data. The relative data in FIG. 16 can be represented in the FIGS. 9-12. These figures show the relative results versus the controls. For samples that performed better than the controls, the breakthrough is greater than 100%. FIGS. 9-12 show 14 day data final test data.

The Effect of Basis Weight. FIG. 9 shows the effect of fiber basis weight. To achieve an 80% breakthrough, it is clear that the seeds can readily penetrate a fiber web of less than about 70 gsm. Increasing levels of crossinked fiber (from 50:50 to 75:25 to 100:0) relative to other fiber in the sheet making up the laminate aids the seeds' ability to escape the seed mat. The effect of basis weight and density is illustrated in FIGS. 18 and 19.

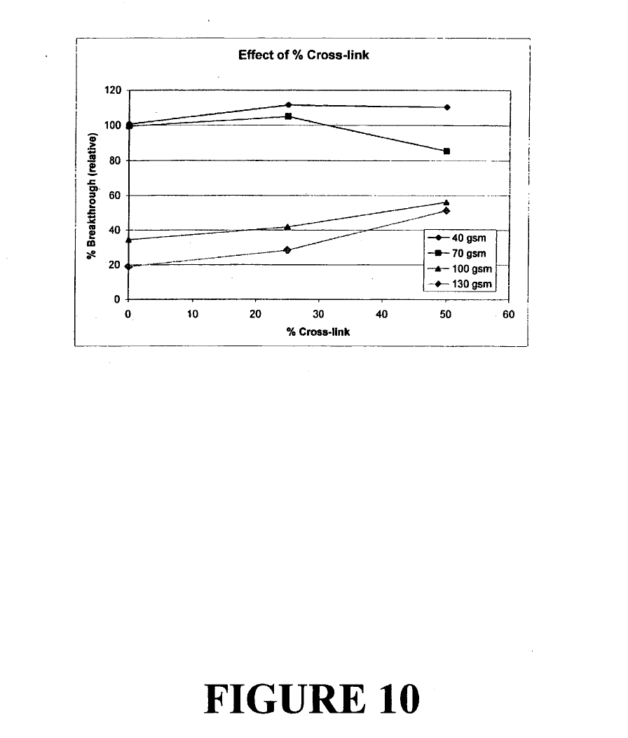

The Effect of Crosslinked Fiber. The effect of crosslinked fiber and basis weight is shown in FIG. 10. At low basis weights, crosslinked fiber is relatively ineffective at allowing additional sprouts to penetrate. At higher basis weights, less than 60% relative breakthrough is achieved, but the presence of some crosslinked fiber does provide some benefit.

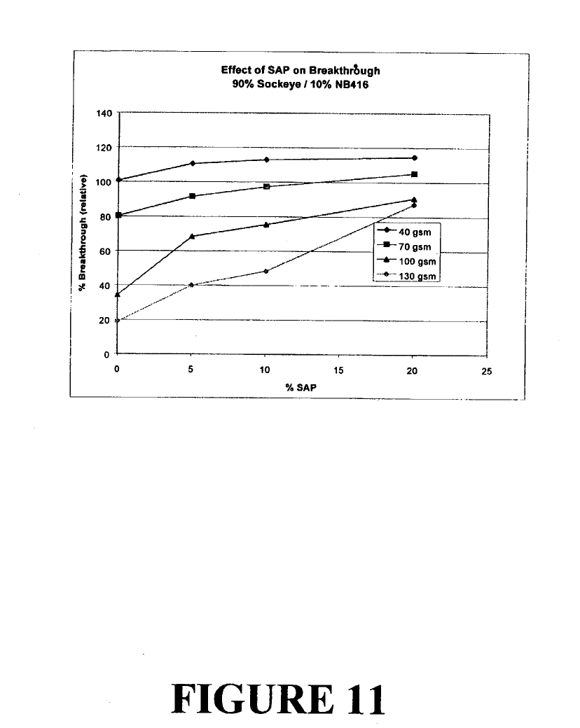

The Effect of Absorbent Material. With the addition of low levels of absorbent material (e.g., superabsorbent polymer, SAP) the structure of the seed mat was expected to open further and allow more sprouts to penetrate. This is evidenced in FIG. 11 where at high basis weights, relative breakthrough values exceeded 80% when 20% SAP was applied to the top layer of the laminate. Lower levels of SAP improved the 100 gsm samples versus similar samples made with cross linked fiber (see FIG. 10).

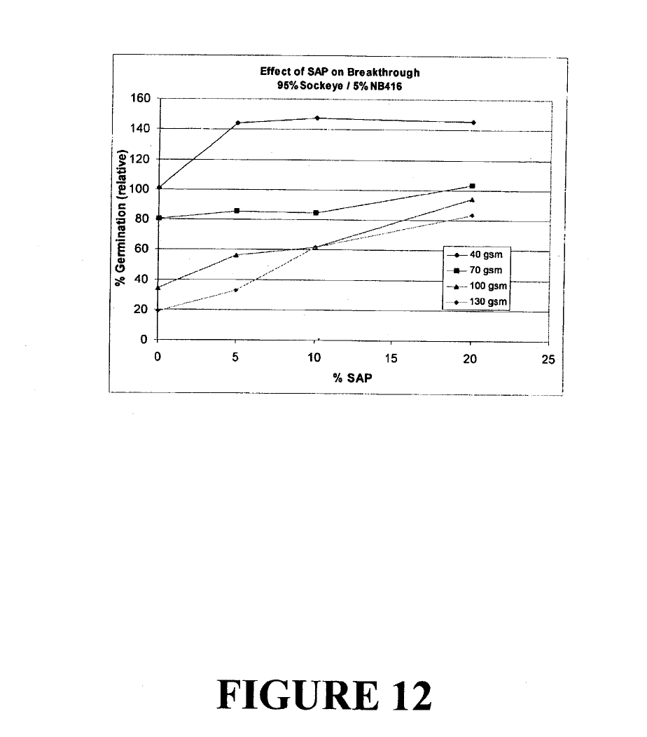

A similar result is shown in FIG. 12. FIG. 11 shows the results for a sample with 10% southern pine fiber (NB416) added for tensile strength. The samples in FIG. 12 have only 5% southern pine added. The difference in the two levels of carrier fiber is seen most dramatically in the lower basis weight samples. FIG. 12 shows much greater relative breakthrough is achieved at the 40 gsm level when 5% carrier is present versus 10% shown in FIG. 11.

The results demonstrate that breakthrough is dependent on basis weight. Low basis products achieve higher and faster breakthrough results. Below about basis weight of about 70 g/m², sprouts appear to penetrate the fibrous sheet without the aid of the presence of crosslinked fibers and/or absorbent material. The presence of crosslinked fibers and absorbent materials improve the breakthrough of sprout in the laminate with top fibrous sheets having basis weights greater than about 70 g/m².

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for making a fibrous product containing a plurality of plant seeds, comprising:
(a) providing a first fibrous sheet;
(b) applying an adhesive to the first fibrous sheet
(c) delivering a plurality of plant seeds onto the first fibrous sheet treated with adhesive;
(d) applying a second fibrous sheet to the first fibrous sheet onto which a plurality of plant seeds has been delivered; and
(e) affixing the second fibrous sheet to the first fibrous sheet to provide the fibrous product.

2. The method of claim 1, wherein the adhesive comprises a vinyl acrylic adhesive.

3. The method of claim 1, wherein the adhesive is applied in an amount from about 5 to about 10 grams per 1000 square inches of fibrous sheet.

4. The method of claim 1, wherein the adhesive is applied to provide individual, noncoalsced adhesive droplets.

5. The method of claim 1, wherein affixing the second fibrous sheet to the first fibrous sheet comprises compacting the first and second fibrous sheets.

6. The method of claim 1, wherein the first and second fibrous sheets are the same.

7. The method of claim 1, wherein the first and second fibrous sheets are different.

8. The method of claim 1, wherein at least one of the first or second fibrous sheets comprises absorbent material.

9. The method of claim 1, wherein at least one of the first or second fibrous sheets includes a superabsorbent polymer.

10. The method of claim 1, wherein at least one of the first or second fibrous sheets comprises from about 5 to about 20% by weight absorbent material based on the total weight of the sheet.

11. The method of claim 1, wherein at least one of the first or second fibrous sheets comprises wood pulp fibers having a kappa value greater than about 10.

12. The method of claim 1, wherein at least one of the first or second fibrous sheets comprises about 100% by weight unbleached Douglas fir pulp fibers based on the total weight of fibers.

13. The method of claim 1, wherein at least one of the first or second fibrous sheets comprises about 95% by weight unbleached Douglas fir pulp fibers and about 5% by weight southern pine fibers based on the total weight of fibers.

14. The method of claim 1, wherein each of the first and second fibrous sheets has a basis weight in the range from about 40 g/m² to about 130 g/m².

15. The method of claim 1, wherein the plant seed comprises a grass seed.
